(19) United States
(12) Patent Application Publication
(10) Pub. No.: US 2016/0334205 A1
(43) Pub. Date: Nov. 17, 2016

(54) INTERFEROMETER

(71) Applicant: Applejack 199 L.P., San Jose, CA (US)

(72) Inventors: ARUN ANANTH AIYER, Fremont, CA (US); TIANHENG WANG, Fremont, CA (US)

(21) Appl. No.: 14/712,780

(22) Filed: May 14, 2015

(51) Int. Cl. G01B 11/14; G01B 9/02; G01B 11/06

(52) U.S. Cl. CPC G01B 11/14; G01B 11/06; G01B 9/02047

(57) ABSTRACT

An interferometer may include a tunable light source, a beam direction unit, a digital imager, and a processor system. The tunable light source may be configured to emit a beam. The beam direction unit may be configured to direct the beam toward a sample with a reference surface and a feature surface. The digital imager may be configured to receive a reflected beam and to generate an image based on the reflected beam. The reflected beam may be a coherent addition of a first reflection of the beam off the reference surface and a second reflection of the beam off the feature surface. The processor system may be coupled to the digital imager and may be configured to determine a distance between the reference surface and the feature surface based on the image.

### FIELD

The embodiments discussed in this disclosure are related to an interferometer.

### BACKGROUND

An interferometer utilizes superimposed waves, such as visible light or electromagnetic waves from other spectral regions, to extract information about the state of the superimposed waves. The superimposition of two or more waves with the same frequency may combine and thus add coherently. The resulting wave from the combination of the two or more waves may be determined by the phase difference between the two or more waves. For example, waves that are in-phase may undergo constructive interference while waves that are out-of-phase may undergo destructive interference. The information extracted from the coherently added waves may be used to determined information about a structure that interacts with the waves. For example, interferometers may be used for measurement of small displacements, refractive index changes, and surface irregularities.

The subject matter claimed in this disclosure is not limited to embodiments that solve any disadvantages or that operate only in environments such as those described above. Rather, this background is only provided to illustrate one example technology area where some embodiments described in this disclosure may be practiced.

### SUMMARY

According to an aspect of one or more embodiments, an interferometer may include a tunable light source, a beam direction unit, a digital imager, and a processor system. The tunable light source may be configured to emit a beam. The beam direction unit may be configured to direct the beam toward a sample with a reference surface and a feature surface. The digital imager may be configured to receive a reflected beam and to generate an image based on the reflected beam. The reflected beam may be a coherent addition of a first reflection of the beam off the reference surface and a second reflection of the beam off the feature surface. The processor system may be coupled to the digital imager and may be configured to determine a distance between the reference surface and the feature surface based on the image.

According to an aspect of one or more embodiments, a method to determine a sample thickness is disclosed. The method may include emitting a light beam and directing the light beam toward a sample with a reference surface and a feature surface. The method may also include generating an image based on a reflected light beam. The reflected light beam may be a coherent addition of a first reflection of the light beam off the reference surface and a second reflection of the light beam off the feature surface. The method may also include determining a distance between the reference surface and the feature surface based on the image.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1A illustrates an example interferometer system;

FIG. 1B illustrates multiple interferometer sub-systems;

FIG. 2A illustrates another example interferometer system;

FIG. 2B illustrates another example interferometer system;

FIG. 3 illustrates an example of beam reflection off an example semiconductor device;

FIG. 4 illustrates an example of beam reflection off another example semiconductor device;

FIG. 5 illustrates an example of beam reflection off another example semiconductor device; and

FIG. 6 is a flowchart of an example method to determine a sample thickness or feature height.

### DESCRIPTION OF EMBODIMENTS

According to at least one embodiment described in this disclosure, an interferometer may include a tunable light source, a beam direction unit, a digital imager, and a processor system. The interferometer may be configured to determine a distance between a reference surface and a feature surface of a sample. The sample may be a portion of a surface of a semiconductor device built on a wafer. In some embodiments, the reference surface may be a top surface of the wafer and the feature surface may be a top surface of the semiconductor device built on the wafer.

In some embodiments, the tunable light source may be configured to emit a light beam with a first wavelength at a first time. The beam direction unit may be configured to direct the beam toward the sample. The beam may reflect off of the sample. In some embodiments, beam may reflect off the reference surface to generate a first reflected beam. The beam may also reflect off of the feature surface to generate a second reflected beam. The first and second reflected beams may coherently added together to form an imaging beam and be received by the digital imager. The digital imager may be configured to generate a digital image based on an intensity of the imaging beam.

The tunable light source may be configured to emit multiple other light beams, each at a different time. Each of the multiple other light beams may have a different wavelength. A digital image may be generated by the digital imager for each of the multiple other light beams in a similar manner as the digital image was generated for the light beam with the first wavelength.

The processor system may be configured to receive the digital images from the digital imager. Based on a comparison between intensity values at the same pixel locations in the digital images, the processor system may be configured to determine a distance between the reference surface and the feature surface of the sample.

In some embodiments, the sample may be a single location. Alternately or additionally, the sample may correspond to an area of the semiconductor. In these and other embodiments, the processor system may be configured to determine a topology of the sample over the area of the semiconductor based on the digital images. The topology may represent the distance between the reference surface and the feature surface over the area of the semiconductor.

In some embodiments, the interferometer may include one or more lens and an adjustable system aperture between the sample and the digital imager. The lens may be configured to focus the imaging beam on the digital imager. The adjustable system aperture may be configured to adjust a field of view and/or spatial resolution of the digital imager. In these and other embodiments, the field of view of the digital imager may correspond with the area of the semiconductor for which the distance between the reference surface and the feature surface is determined.

In some embodiments, a system may include multiple interferometers systems. In these and other embodiments, each of the systems may determine a distance between a reference surface and a feature surface of the semiconductor for different portions of the semiconductor. In this manner, a topology of an entire semiconductor may be more quickly determined than when using a single interferometer.

Embodiments of the present disclosure will be explained with reference to the accompanying drawings.

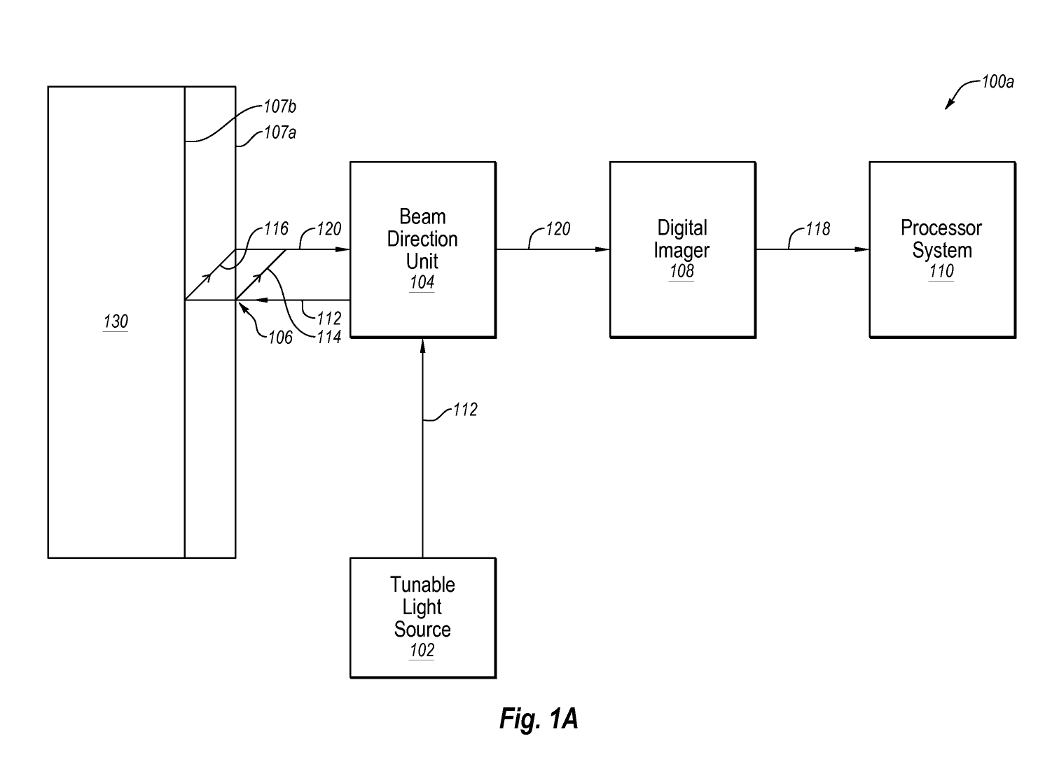

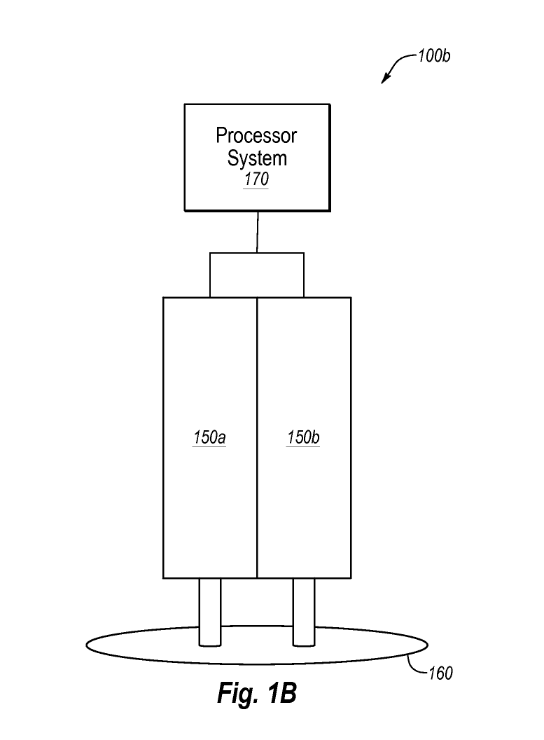

FIG. 1A illustrates an example interferometer system 100a (the “system 100a”), arranged in accordance with at least some embodiments described in this disclosure. In general, the system 100a may be configured to determine a distance between a feature surface 107a and a reference surface 107b at a sample 106 that is part of a semiconductor device 130 using light beams. To determine the distance, the system 100a may include a tunable light source 102, a beam direction unit 104, a digital imager 108, and a processor system 110.

The system 100a may be implemented with respect to any suitable application where a distance may be measured. For example, in some embodiments, the feature surface 107a may be top surface feature of a semiconductor device 130 and the reference surface 107b may be a top or bottom surface of a silicon substrate wafer that forms a substrate of the semiconductor device 130. In these and other embodiments, the semiconductor device 130 may be any circuit, chip, or device that is fabricated on a silicon wafer. The semiconductor device 130 may include multiple layers of the same or different materials between the feature surface 107a and the reference surface 107b. Alternately or additionally, the feature surface 107a may be a MEMS structure and the reference surface 107b may be a surface on which the MEMS structure is built.

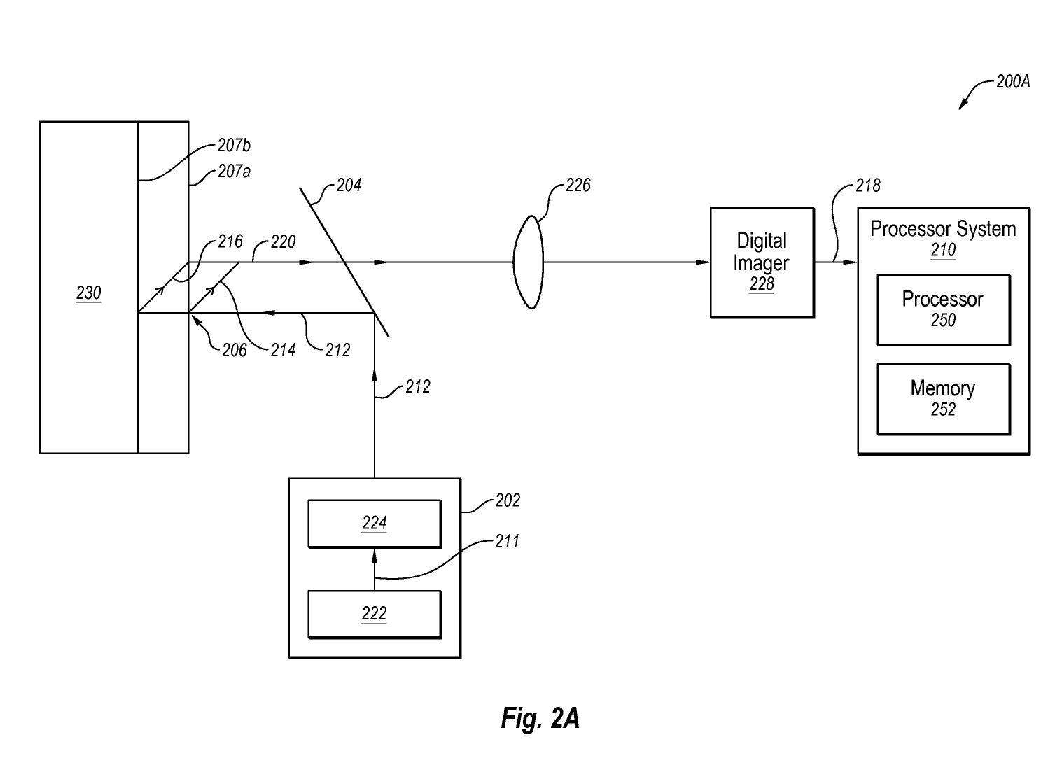

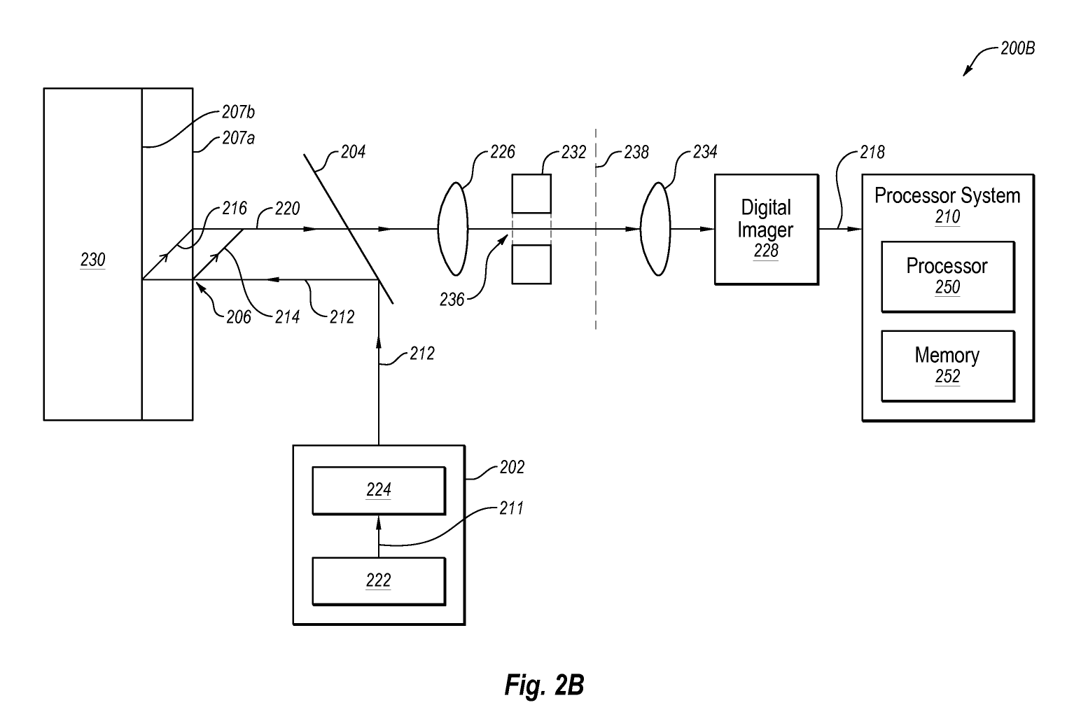

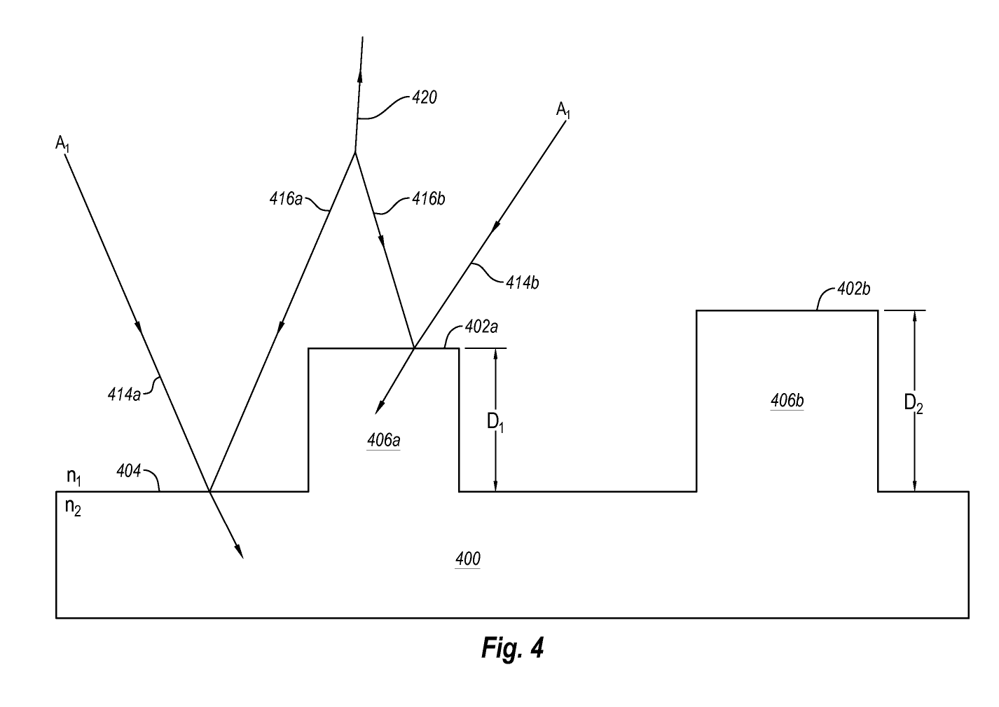

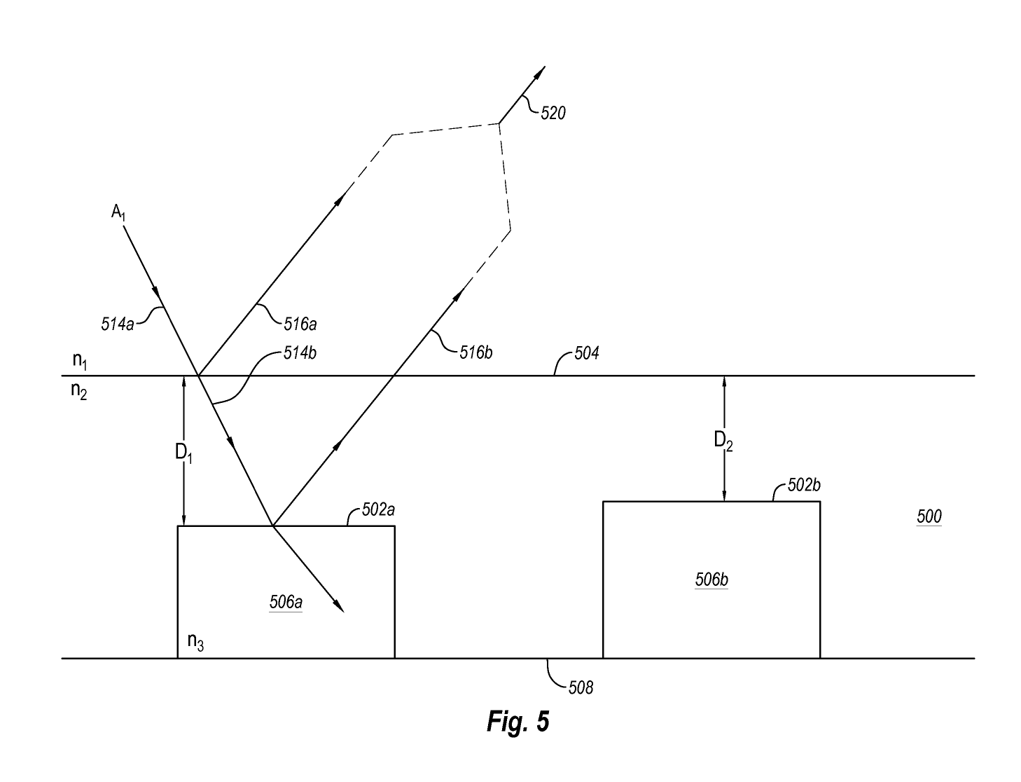

Alternately or additionally, the feature surface 107a may be any type of interconnect feature used in 3D packaging and the reference surface 107b may be the corresponding surface from which the interconnect features protrude. An example of a protruding feature and a reference surface is described with respect to FIG. 4. Alternately or additionally, the feature surface 107a may be an embedded surface within a semiconductor device or some other device and the reference surface may be a top surface. An example of an embedded surface is described with respect to FIG. 5. Although FIGS. 1, 2A, and 2B illustrates one feature surface configurations, the principles and operation of the systems described in FIGS. 1, 2A, and 2B may be applied to any feature surface configuration.

The tunable light source 102 may be configured to generate and to emit a light beam 112. In some embodiments, the tunable light source 102 may be a broadband light source that is tunable to multiple different wavelengths. For example, the tunable light source 102 may be tuned over a range of frequencies at various wavelength tuning steps. In some embodiments, the tunable light source 102 may have a bandwidth that is between 300 nanometers (nm) and 1000 nm, between 1000 nm and 2000 nm, or some other bandwidth. For example, the tunable light source 102 may have a bandwidth that is between 650 nm and 950 nm. In some embodiments, the tuning step of the tunable light source 102 may be more or less than 1 nm. The tunable light source 102 may provide the light beam 112 at a first wavelength to the beam direction unit 104.

The beam direction unit 104 may be optically coupled to the tunable light source 102, the sample 106, and the digital imager 108. The beam direction unit 104 may be configured to receive the light beam 112 and to direct the light beam 112 towards the sample 106. After being directed by the beam direction unit 104, the light beam 112 may strike the feature surface 107a of the sample 106. Striking the feature surface 107a of the sample 106 may generate a first light beam reflection 114. Alternately or additionally, a portion of the light beam 112 may traverse through the sample 106 to the reference surface 107b and strike the reference surface 107b. Striking the reference surface 107b may generate a second light beam reflection 116.

The first light beam reflection 114 may be directed toward the beam direction unit 104. The second light beam reflection 116 may also be directed toward the beam direction unit 104. In these and other embodiments, the first light beam reflection 114 and the second light beam reflection 116 may coherently add to form a reflected light beam 120.

In some embodiments, the beam direction unit 104 may be configured to receive the reflected light beam 120 and direct the reflected light beam 120 towards the digital imager 108.

The digital imager 108 may be configured to receive the reflected light beam 120 and to generate an image 118 based on an intensity of the reflected light beam 120. In some embodiments, the digital imager 108 may be CMOS or CCD type imager or other types of array detectors. In these and other embodiments, the digital imager 108 may include multiple pixels. Each of the pixels may be configured such that, when illuminated, each pixel provides information about the intensity of the illumination that is striking the pixel. The digital imager 108 may compile the information from the pixels to form the image 118. The image 118 may thus include the intensity information for each of the pixels. The image 118, when including the intensity information for each pixel, may be referred to as a grayscale digital image. The digital imager 108 may provide the image 118 to the processor system 110.

The processor system 110 may be electrically coupled to the digital imager 108. In these and other embodiments, the processor system 110 may receive the image 118. Based on the image 118, the processor system 110 may be configured to determine a distance between the feature surface 107a and the reference surface 107b.

In some embodiments, the tunable light source 102 may be configured to generate the light beam 112 as a point light source with a smaller diameter beam. In these and other embodiments, an area of the sample 106 may be small and restricted to a particular location on the semiconductor device 130. In these and other embodiments, the distance between the feature surface 107a and the reference surface 107b may be determined for the particular location. Alternately or additionally, the tunable light source 102 may be configured to generate the light beam 112 as a larger collimated light beam. In these and other embodiments, an area of the sample 106 may be larger. The sample 106 of the semiconductor device 130 that is illuminated may be 1 mm² or larger. In these and other embodiments, the image 118 may be formed based on the reflected light beam 120 from the sample 106. Thus, the image 118 may be an image of an entire area of the sample 106 and not a single location of the semiconductor device 130.

In these and other embodiments, particular pixels in the image 118 may correspond with particular locations in the area of the sample 106. In these and other embodiments, the processor system 110 may be configured to determine a distance between the feature surface 107a and the reference surface 107b at multiple different locations within the area of the sample 106. In these and other embodiments, the processor system 110 may use intensity information from particular pixels in the image 118 to determine the distance between the feature surface 107a and the reference surface 107b at particular locations of the sample 106 that correspond with the particular pixels in the image 118.

For example, a first pixel or a first group of pixels in the image 118 may receive a portion of the reflected light beam 120 that reflected from a first location of the sample 106. A second pixel or a second group of pixels in the image 118 may receive a portion of the reflected light beam 120 that reflected from a second location of the sample 106. Thus, the first pixel in the image 118 may have a grayscale value that is based on or the first group of pixels in the image 118 may have grayscales values that are based on the intensity of the reflected light beam 120 that reflected from a first location of the sample 106. Furthermore, the second pixel in the image 118 may have a grayscale value that is based on or the second group of pixels in the image 118 may have grayscales values that are the intensity of the reflected light beam 120 that reflected from the second location of the sample 106.

In these and other embodiments, the processor system 110 may be configured to determine the distance between the feature surface 107a and the reference surface 107b at the first location of the sample 106 based on the grayscale value(s) of the first pixel or the first group of pixels. The processor system 110 may also be configured to determine the distance between the feature surface 107a and the reference surface 107b at the second location of the sample 106 based on the grayscale value(s) of the second pixel or the second group of pixels. In these and other embodiments, the distance between the feature surface 107a and the reference surface 107b at the first location and the second location may be different. In these and other embodiments, based on the different distances between the feature surface 107a and the reference surface 107b at different locations of the sample 106, the processor system 110 may generate a topology of the area of the sample 106 that reflects the different distances between the feature surface 107a and the reference surface 107b at different locations of the sample 106.

As noted, the different intensities of the reflected light beam 120 received by different pixels of the digital imager 108 may result from different distances between the feature surface 107a and the reference surface 107b at different locations of the sample 106. The different distances between the feature surface 107a and the reference surface 107b at different locations of the sample 106 may result in different path length differences traversed by the first light beam reflection 114 and the second light beam reflection 116 at different locations of the sample 106. The different path length differences may result in different phase differences between the first light beam reflection 114 and the second light beam reflection 116 from the different locations. The different phase differences may result in a change in intensity when the first light beam reflection 114 and the second light beam reflection 116 add coherently to form the reflected light beam 120. The first light beam reflection 114 and the second light beam reflection 116 may add coherently generating an intensity (grayscale) pattern that is dependent on the phase difference between the first light beam reflection 114 and the second light beam reflection 116. For example when the first light beam reflection 114 and the second light beam reflection 116 are in-phase, the first light beam reflection 114 and the second light beam reflection 116 may interfere constructively (strengthening in intensity). As another example, when the first light beam reflection 114 and the second light beam reflection 116 are out-of-phase, the first light beam reflection 114 and the second light beam reflection 116 may interfere destructively (weakening in intensity). These changes in intensity differences may be represented by the different grayscale values of the pixels in the image 118.

An example of the operation of the system 100a is now described. In some embodiments, the tunable light source 102 may be configured to generate and to emit multiple different light beams 112. Each of the multiple different light beams 112 may be generated at a different time and at a different wavelength. In some embodiments, the different wavelengths of the different light beams 112 may result in different intensities of the reflected light beams 120. The different intensities may be due to the different wavelengths of the different light beams 112 causing differences in the phase differences between the first light beam reflection 114 and the second light beam reflection 116 when coherently added. For example, at a first wavelength of the light beam 112, the first light beam reflection 114 and the second light beam reflection 116 may have a first phase difference. At a second wavelength of the light beam 112, the first light beam reflection 114 and the second light beam reflection 116 may have a second phase difference. The coherent addition with different phase differences may cause the first light beam reflection 114 and the second light beam reflection 116 to produce the reflected light beam 120 with different intensities.

Each of the different reflected light beams 120 may be used to generate a different image 118 by the digital imager 108. The processor system 110 may receive and store each of the different images generated by the digital imager 108. The processor system 110 may use the different images to determine the distance between the feature surface 107a and the reference surface 107b.

In some embodiments, the processor system 110 may use the different intensities of the reflected beams 120 as recorded by the different images to determine the distance between the feature surface 107a and the reference surface 107b. For example, in some embodiments, the processor system 110 may extract the grayscale value, representing an intensity value, for a corresponding pixel of each image 118. The corresponding pixel in each image 118 may correspond with a particular pixel in the digital imager 108. Thus, a particular pixel in each image 118 may be generated from the same pixel in the digital imager 108. The grayscale values for the particular pixel in each image 118 may be plotted to form a fringe pattern with a sinusoidal waveform or a modulated sinusoidal waveform. For example, the intensity values of the particular pixel from the different images may be along the y-axis and the wavelength of the light beam 112 used to generate the different images may be plotted along the x-axis. In these and other embodiments, the distance between the feature surface 107a and the reference surface 107b at a particular point corresponding to the particular pixel may be determined based on the fringe pattern.

For example, in some embodiments, the distance between the feature surface 107a and the reference surface 107b at a particular point corresponding to the particular pixel may be determined based on a Fast Fourier Transform (FFT) of the fringe pattern. Alternately or additionally, in some embodiments, the distance between the feature surface 107a and the reference surface 107b at a particular point corresponding to the particular pixel may be determined based on a comparison between a model based predicted fringe pattern and the determined pixel intensity fringe patterns from the images 118. Each of the model based predicted fringe patterns may be constructed for a different distance based on previous actual results or theoretical mathematical expressions. For example, a relationship between a phase difference and an intensity of reflected light beam 120 may be determined by the following theoretical mathematical expression:

$${I}_{0} = {I}_{1} + {I}_{2} + 2 \sqrt{{I}_{1} {I}_{2}} cos ( \frac{2 π d}{λ} )$$

In the above expression, “I₁” may refer to the intensity of the first light beam reflection 114 from the feature surface 107a, “I₂” may refer to the intensity of the second light beam reflection 116 from the reference surface 107b, “d” may refer to the optical height of the feature, “λ” may refer to the wavelength of the light beam 112, and “I₀” may refer to the intensity of the reflected light beam 120 by adding the first light beam reflection 114 and the second light beam reflection 116 coherently. Based on the above expression, the model based predicted fringe patterns may be created for determining the optical height of the feature “d”.

In these and other embodiments, the fringe pattern determined from Processor system, 110 may be compared to each or some of the model based predicted fringe patterns. The model based predicted fringe patterns closest to the determined fringe pattern may be selected and the distance for which the selected model based predicted fringe was constructed may be the determined distance between the feature surface 107a and the reference surface 107b.

In some embodiments, the processor system 110 may perform an analogous analysis for each pixel of the different images 118. Using the distance information from each pixel, the processor system 110 may determine a topology of the area of the sample 106 illuminated by the light beam 112.

In some embodiments, a number of different light beams 112 with different wavelengths used by the system 100a and thus a number of different images generated by the digital image 108 may be selected based on an estimated distance between the feature surface 107a and the reference surface 107b. When the distance between the feature surface 107a and the reference surface 107b is small, such as below 1 micrometer (μm), the number of different light beams 112 may be increased as compared to when the distance between the feature surface 107a and the reference surface 107b is larger, such as above 1 μm. In these and other embodiments, the an inverse relationship between the distance to be determined between the feature surface 107a and the reference surface 107b and the number of different light beams 112 may exist. As such, a bandwidth of the wavelengths covered by the different light beams 112 may have an inverse relationship with the distance to be determined between the feature surface 107a and the reference surface 107b.

Alternately or additionally, a relationship between the distance to be determined between the feature surface 107a and the reference surface 107b and a wavelength step-size between different light beams 112 may also have an inverse relationship. Thus, for a small size distance between the feature surface 107a and the reference surface 107b, the wavelength step-size may be a first wavelength step-size. For a medium size distance between the feature surface 107a and the reference surface 107b, the wavelength step-size may be a second wavelength step-size and for a large size distance between the feature surface 107a and the reference surface 107b, the wavelength step-size may be a third wavelength step-size. In these and other embodiments, the third wavelength step-size may be smaller than the first and second wavelength step-size and the second wavelength step-size may be smaller than the first wavelength step-size. Additionally, the bandwidth of each light beam 112 corresponding to each wavelength step may get smaller as the distance between the feature surface 107a and the reference surface 107b increases.

In some embodiments, the semiconductor device 130 may be repositioned with respect to the system 100a. For example, the semiconductor device 130 may be moved or the system 100a may be moved. In these and other embodiments, the system 100a may be configured to determine a distance between the feature surface 107a and the reference surface 107b from a second sample of the semiconductor device 130. The second sample of the semiconductor device 130 may have been a portion of the semiconductor device 130 that was previously unilluminated by the light beam 112 or for which reflections from second sample did not reach the digital imager 108. In these and other embodiments, the semiconductor device 130 may be repositioned such that entire surface of the semiconductor device 130 may be a sample for which the distance between the feature surface 107a and the reference surface 107b is determined. In these and other embodiments, the system 100a may be repositioned such that entire surface of the semiconductor device 130 may be a sample for which the distance between the feature surface 107a and the reference surface 107b is determined.

Modifications, additions, or omissions may be made to the system 100a without departing from the scope of the present disclosure. For example, in some embodiments, the system 100a may include optical components between the beam direction unit 104 and the digital imager 108 as illustrated in FIGS. 2A and 2B.

The system 100a as described may provide various differences with previous distance measurement concepts. For example, in some embodiments, because both the feature surface 107a and the reference surface 107b are illuminated by the same light beam 112, vibrations of the semiconductor device 130 are inherent in both the first light beam reflection 114 and the second light beam reflection 116 such that the system 100a may compensate for the vibrations. Alternately or additionally, a single light beam 112 may be used to determine the distance as compared to multiple light beams.

In some embodiments, an interferometer system may include multiple tunable light sources, beam direction units, and digital imagers. In some embodiments, an interferometer system may include single tunable light sources, multiple beam direction units, and digital imagers. In these and other embodiments, a tunable light source, a beam direction unit, and a digital imager may be referred to in this disclosure as an interferometer sub-systems.

FIG. 1B illustrates multiple interferometer sub-systems 150a and 150b in an example interferometer system 100b, arranged according to at least some embodiments described in this disclosure. Each of the sub-systems 150a and 150b may include a tunable light source, a beam direction unit, and a digital imager analogous to the tunable light source 102, the beam direction unit 104, and the digital imager 108 of FIG. 1A. Each of the sub-systems 150a and 150b may be configured to illuminate a different portion of a semiconductor device 160. Images generated by each of the sub-systems 150a and 150b may be provided to a processor system 170 that is analogous to the processor system 110 of FIG. 1A. The processor system 170 may be configured to determine distances between a reference surface and a features surface of the semiconductor device 160 based on the images from the sub-systems 150a and 150b. Thus, in these and other embodiments, multiple samples of the semiconductor device 130 may be processed at the same time, in parallel. By processing multiple samples at the same time, a distance between the feature surface and the reference surface across the semiconductor device 160 may be determined in less time than when portions of the semiconductor device 160 are processed linearly or one at a time.

Modifications, additions, or omissions may be made to the system 100b without departing from the scope of the present disclosure. For example, each of the sub-systems 150a and 150b may include a processor system. In these and other embodiments, one of the processor systems may compile information for the entire semiconductor device 160 from other of the processors systems.

FIG. 2A illustrates another example interferometer system 200A (the “system 200A”), according to at least some embodiments described in this disclosure. In general, the system 200A may be configured to determine a distance between a feature surface 207a and a reference surface 207b at a sample 206 that is part of a semiconductor device 230 using light beams. To determine the distance, the system 200 may include a tunable light source 202, a beam splitter 204, a first lens 226, a digital imager 228, and a processor system 210.

The system 200A may be implemented with respect to any suitable application where a distance may be measured. For example, in some embodiments, the feature surface 207a may be a top surface of a semiconductor device 230 and the reference surface 207b may be a top surface of a silicon substrate wafer that forms a substrate of the semiconductor device 230.

The tunable light source 202 may be configured to generate and to emit a light beam 212. The tunable light source 202 may be analogous to the tunable light source 102 of FIG. 1 and may be configured to provide a light beam 212 at a particular wavelength. As illustrated in FIG. 2A, in some embodiments, the tunable light source 202 may include a broadband light source 222 and a tunable filter 224 that are optically coupled. The broadband light source 222 may be configured to emit a broadband light beam 211 that includes wavelengths of light that may be used by the system 200. In some embodiments, the broadband light source 222 may be a light source such as a white light or a super luminescent diode (SLED). In some embodiments, the broadband light source 222 may be configured to provide the broadband light beam 211 with a Gaussian power spectrum.

The tunable filter 224 may be configured to filter the broadband light beam 211 to generate the light beam 212 at a particular wavelength. In some embodiments, the tunable filter 224 may be tuned, such that the tunable filter 224 may filter different wavelengths of light to generate the light beam 212 at multiple different wavelengths of light.

In some embodiments, the beam splitter 204 may be configured to receive the light beam 212 and to direct the light beam 212 towards the sample 206. In some embodiments, the beam splitter 204 may be configured to reflect and transmit a portion of the light beam 212. For example, the beam splitter 204 may reflect 50 percent and transmit 50 percent of the light beam 212. Alternately or additionally, the beam splitter 204 may reflect a different percent of the light beam 212. In these and other embodiments, the reflected portion of the light beam 212 may be directed to the sample 206.

The sample 206 may be analogous to the sample 106 in FIG. 1. In these and other embodiments, the light beam 212 may be reflected by the feature surface 207a and the reference surface 207b of the sample 206 to form the reflected light beam 220. The reflected light beam 220 may be received by the beam splitter 204. The beam splitter 204 may reflect a portion and transmit a portion of the reflected light beam 220. The transmitted portion of the reflected light beam 220 may be provided to the first lens 226.

The first lens 226 may be configured to receive the reflected light beam 220 from the beam splitter 204. The first lens 226 may pass and focus the reflected light beam 220 onto the digital imager 228. The digital imager 228 may include an image sensor. The image sensor may be a CMOS image sensor, a CCD image sensor, or other types of array detectors. The digital imager 228 may generate an image 218 based on the reflected light beam 220 and pass the image 218 to the processor system 210.

The processor system 210 may be analogous to and configured to operate in a similar manner as the processor system 110 of FIG. 1. The processor system 210 may be implemented by any suitable mechanism, such as a program, software, function, library, software as a service, analog, or digital circuitry, or any combination thereof. In some embodiments, such as illustrated in FIG. 2A, the processor system 210 may include a processor 250 and a memory 252. The processor 250 may include, for example, a microprocessor, microcontroller, digital signal processor (DSP), application-specific integrated circuit (ASIC), a Field-Programmable Gate Array (FPGA), or any other digital or analog circuitry configured to interpret and/or to execute program instructions and/or to process data. In some embodiments, the processor 250 may interpret and/or execute program instructions and/or process data stored in the memory 252. For example, the image 218 generated by the digital imager 228 may be stored in the memory 252. The processor 250 may execute instructions to perform the operations with respect to the image 218 to determine the distance between the feature surface 207a and the reference surface 207b.

The memory 252 may include any suitable computer-readable media configured to retain program instructions and/or data, such as the image 218, for a period of time. By way of example, and not limitation, such computer-readable media may include tangible and/or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable media. Computer-executable instructions may include, for example, instructions and data that cause a general-purpose computer, special-purpose computer, or special-purpose processing device to perform a certain function or group of functions. Modifications, additions, or omissions may be made to the system 200A without departing from the scope of the present disclosure.

FIG. 2B illustrates another example interferometer system 200B (the “system 200B”), according to at least some embodiments described in this disclosure. In general, the system 200B is analogous to the system 200A of FIG. 2A, expect that the system 200B further includes a second lens 234 and an adjustable aperture device 232.

The second lens 234 may be positioned between the first lens 226 and the digital imager 228. The second lens 234 may be configured to receive the reflected light beam 220. The second lens 234 may also be configured to further focus the reflected light beam 220 onto the digital imager 228. In some embodiments, the first lens 226 and the second lens 234 may be convex lens with a similar or same focal length. Alternately or additionally, the first lens 226 and the second lens 234 may be different type of lens or each may be a different type of lens or compound lenses or the lens may have different focal lengths.

The adjustable aperture device 232 may be configured to adjust a size of an aperture 236 through which the reflected light beam 220 may travel. In some embodiments, the adjustable aperture device 232 may be positioned between the first and second lens 226 and 234. Alternately or additionally, the adjustable aperture device 232 may be positioned between the first lens 226 and the beam splitter 204. In some embodiments, the aperture 236 of the adjustable aperture device 232 may result in an adjustable system pupil plane 238. A position of the adjustable system pupil plane 238 may be based on a position of the adjustable aperture device 232 in an imaging path that includes the first lens 226, the adjustable aperture device 232, the second lens 234, and the digital imager 228. In some embodiments, a position of the adjustable system pupil plane 238, and thus the position of the adjustable aperture device 232, may be determined based on whether the adjustable system pupil plane 238 is configured to control spatial resolution or field of view of the digital imager 228.

In some embodiments, the size of the aperture 236 may be adjusted based on a feature size in an area of the sample 206. In some embodiments, the size of the aperture 236 may be adjusted based on a required spatial resolution of the area of the sample 206 that is being imaged by the digital imager 228. In these and other embodiments, adjusting the size of the aperture 236 may affect at least one or more of: a cone angle or a numerical aperture of the reflected light beam 220 on the first lens 226; collimation of the reflected light beam 220; sharpness of the image 218 generated by the digital imager 228; depth of focus, the field of view and spatial resolution on the digital imager 228, among others.

In some embodiments, the system 200B may be configured before determining a distance between the feature surface 207a and the reference surface 207b. In these and other embodiments, the size of the aperture 236 may be selected. The size of the aperture 236 may be selected based on an area of the sample 206. The area of the sample 206 may be an area in a plane that includes at least a portion of the feature surface 207a and that is perpendicular to the plane that includes the distance between the feature surface 207a and the reference surface 207b. In these and other embodiments, the larger the area of the sample 206, the smaller the size of the aperture 236 and the smaller the area of the sample 206, the larger the size of the aperture 236. Alternately or additionally, the size of the aperture 236 may be based on a size of a feature of the semiconductor device 230 within the sample 206. In these and other embodiments, when the lateral size of the feature is small, the size of the aperture 235 is larger. When the lateral size of the feature is larger, the size of the aperture 235 is smaller. The size of the aperture 236 may be calculated based on the area of the sample 206. Alternately or additionally, the memory 252 may include a look-up table that includes varies aperture sizes that correspond to areas of the sample 206.

In some embodiments, configuring the system 200B may include setting an exposure time and gain of the digital imager 228. In these other embodiments, an initial exposure time and gain may be selected for the digital imager 228. The initial exposure time and gain may be selected based on the area and the reflectivity of the sample 206.

After selecting the initial exposure time and gain, the light beam 212 may illuminate the sample 206 and an image may be captured by the digital imager 228. The image may be processed to determine if any pixels of the digital imager 228 saturated when being exposed to the reflected light beam 220. Saturation may be determined when there is flat line of a grayscale value across multiple adjacent pixels in the digital imager 228. Saturation may occur when the distance between the reference surface 207b and the feature surface 207a is such that the phases of the first light beam reflection 214 and the second light beam reflection 216 add coherently in a manner that increases the illumination intensity of the reflected light beam 220 to a level that causes the saturation. When it is determined that some of the pixels of the digital imager 228 are saturated, the gain and/or the exposure time may be adjusted by being reduced. For example, the gain may be reduced ten percent. The process of checking for saturation of the digital imager 228 may be repeated and the gain and the exposure time further reduced until the little or no saturation of pixels occurs at a particular wavelength of the light beam 212. In these and other embodiments, the particular wavelength selected may be the wavelength with the highest power. Using the wavelength with the highest power during configuration, may reduce the likelihood of saturation of pixels with wavelengths of lower power during operation of the system 200B.

In some embodiments, configuring the system 200B may include selecting a range of wavelengths for the light beams 212 and the wavelength step size between light beams 212. In some embodiments, the range of wavelengths for the light beams 212 and the wavelength step size may be selected based on a shortest distance between the feature surface 207a and the reference surface 207b over the area of the sample 206. In these and other embodiments, an approximate or estimated shortest distance may be selected based on a construction of the semiconductor device 230. In these and other embodiments, the range of wavelengths for the light beams 212 and the wavelength step size are then selected based on the shortest distance. As discussed previously, the range of wavelengths for the light beams 212 and the wavelength step size may have an inverse relationship with respect to distance between the feature surface 207a and the reference surface 207b.

Modifications, additions, or omissions may be made to the system 200B without departing from the scope of the present disclosure. For example, in some embodiments, the adjustable aperture device 232 may be located between the first lens 226 and the beam splitter 204. In these and other embodiments, the system 200B may not include the second lens 234.

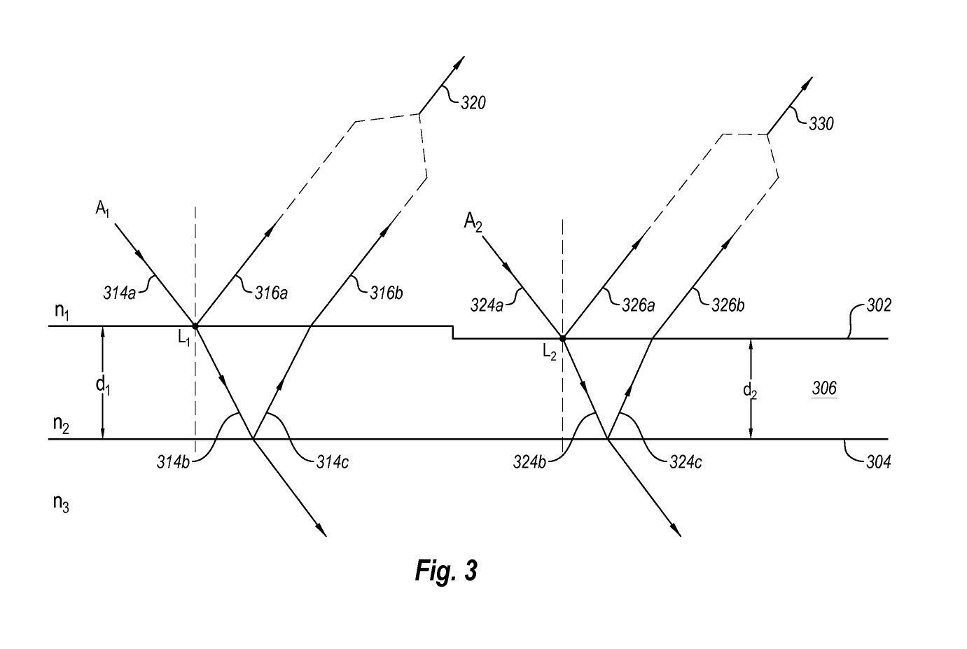

FIG. 3 illustrates an example of beam reflection off a semiconductor device 306 with a reference surface 304 and a feature surface 302, according to at least one embodiment described in this disclosure. In an example embodiment, the semiconductor device 306 may be configured to receive, at a first location L1, an incident light beam 314a at time t from a first light source A1 with a first wavelength. Additionally, the semiconductor device 306 may be configured to receive, at a second location L2, an incident light beam 324a at time t from a second light source A2 with a second tuned wavelength. In these and other embodiments, the first and second lights sources A1 and A2 may be from separate interferometer systems, such as from two of the systems 100a, 200A, or 200B, of FIGS. 1, 2A, and 2B. In these and other embodiments, a distance between the first location L1 and the second location L2 may be larger than a field of view of an interferometer system described in this disclosure. In these and other embodiments, a wavelength of the first light source A1 and a wavelength of the second light source A2 may be the same where the first distance d1 and the second distance d2 are the same or substantially the same, and may be different in other embodiments where the first distance d1 and the second distance d2 are different.

In some embodiments, the first light source A1 and the second light source A2 may be the same single light source from a single interferometer system when the distance between the first location L1 and the second location L2 allows the light source to illuminate the first and locations L1 and L2 at the same time.

A first distance between the feature surface 302 and the reference surface 304 at the first location L1 may be defined as d1. A second distance between the feature surface 302 and the reference surface 304 at the second location L2 may be defined as d2. The first distance d1 and the second distance d2 may be the same in some embodiments and different from each other in other embodiments.

When the incident light beam 314a hits the feature surface 302 of the semiconductor device 306 at the first location L1, a part of the incident light beam 314a may be reflected off the feature surface 302 and generate a first reflective beam 316a. The rest of the incident light beam 314a may pass across the feature surface 302 and generate a refractive beam 314b. The refractive beam 314b may hit the reference surface 304 of the semiconductor device 306 and part of the refractive beam 314b, e.g. 314c, may be reflected off the reference surface 304 of the semiconductor device 306, pass across the feature surface 302 of the semiconductor device 306, being refracted at the feature surface 302, and generate a second reflective beam 316b at the first location L1. The first reflective beam 316a and the second reflective beam 316b may add coherently and generate a reflected beam 320. For example, the first reflective beam 316a and the second reflective beam 316b may add coherently and pass through the first lens 226, the aperture 236, and the second lens 234 as illustrated and described with respect to FIG. 2A and FIG. 2B, and be provided to the digital imager 228.

Similarly, when the incident light beam 324a hits the feature surface 302 of the semiconductor device 306 at the second location L2, a part of the incident light beam 324a may be reflected off the feature surface 302 and generate a first reflective beam 326a. The rest of the incident light beam 324a may pass across the feature surface 302 and generate a refractive beam 324b. The refractive beam 324b may hit the reference surface 304 of the semiconductor device 306 and part of the refractive beam 324b, e.g. 324c, may be reflected off the reference surface 304 of the semiconductor device 306, pass across the feature surface 302 of the semiconductor device 306, being refracted at the feature surface 302, and generate a second reflective beam 326b at the second location L2. The first reflective beam 326a and the second reflective beam 326b may add coherently and generate a reflected beam 330. For example, the first reflective beam 326a and the second reflective beam 326b may add coherently and pass through the first lens 226, the aperture 236, and the second lens 234 as illustrated and described with respect to FIG. 2A and FIG. 2B, and be provided to the digital imager 228. Modifications, additions, or omissions may be made to the semiconductor device 306 without departing from the scope of the present disclosure

FIG. 4 illustrates an example of beam reflection off another example semiconductor device 400, arranged in accordance with at least some embodiments described in this disclosure. The semiconductor device 400 may include a first raised portion 406a and a second raised portion 406b that extend above a reference surface 404 of the semiconductor device 400. A top surface of the first raised portion 406a may be a first feature surface 402a of the semiconductor device 400. A top surface of the second raised portion 406b may be a second feature surface 402b of the semiconductor device 400. Using light beams and an interferometer system described in some embodiments in the present disclosure, a distance D1 between the reference surface 404 and the first feature surface 402a may be determined. The distance D1 may represent a distance that the first feature surface 402 extends out from the reference surface 404. Alternately or additionally, a distance D2 between the reference surface 404 and the second feature surface 402b may be determined. In some embodiments, the reference surface 404 may be at varying heights with respect to the first and second raised portions 406a and 406b. For example, the reference surface 404 to the left of the first raised portion 406a may be higher than the reference surface 404 to the right of the second raised portion 406b.

FIG. 4 illustrates a light beam 414 from a light source A1. The light beam 414 includes a first light beam portion 414a that is striking the reference surface 404 and a second light beam portion 414b that is striking the first feature surface 402a. A part of the first light beam portion 414a may be reflected off the reference surface 404 and generate a first reflective beam 416a. The rest of the first light beam portion 414a may pass through the semiconductor device 400 and/or incur additional reflections or refractions.

A part of the second light beam portion 414b may be reflected off the first features surface 402a and generate a second reflective beam 416b. The rest of the second light beam portion 414b may pass through the semiconductor device 400 and/or incur additional reflections or refractions.

The first and second reflective beams 416a and 416b may coherently add to form a reflected beam 420. In some embodiments, the reflected beam 420 may pass through the first lens 226, the aperture 236, and the second lens 234 as illustrated and described with respect to FIG. 2A and FIG. 2B, and be provided to the digital imager 228. An image may be formed using at least the intensity of the reflected beam 420. The image may be part of a collection of images that may be used to determine the distance D1.

In some embodiments, the light source A1 may also illuminate the second raised portion 406b. In a similar manner as described with respect to the first raised portion 406a, a reflected beam may be formed and captured to form an image. The image may be part of a collection of images that may be used to determine the distance D2. Modifications, additions, or omissions may be made to the semiconductor device 400 without departing from the scope of the present disclosure.

FIG. 5 illustrates an example of beam reflection off another example semiconductor device 500, arranged in accordance with at least some embodiments described in this disclosure. The semiconductor device 500 may include a first raised portion 506a and a second raised portion 506b that extend from a first surface 508 toward a reference surface 504 of the semiconductor device 500. A top surface of the first raised portion 506a may be a first feature surface 502a of the semiconductor device 500. A top surface of the second raised portion 506b may be a second feature surface 502b of the semiconductor device 500. Using light beams and an interferometer system described in some embodiments in the present disclosure, a distance D1 between the reference surface 504 and the first feature surface 502a may be determined. The distance D1 may represent a distance that the first feature surface 502a is below the reference surface 504. Alternately or additionally, a distance D2 between the reference surface 504 and the second feature surface 502b may be determined. In some embodiments, the reference surface 504 may be at varying heights with respect to the first and second raised portions 506a and 506b.

FIG. 5 illustrates a light beam 514a from a light source A1. The light beam 514a may strike the reference surface 504. A part of the light beam 514a may be reflected off the reference surface 504 and generate a first reflective beam 516a. The rest of the light beam 514a may pass across the reference surface 504 and generate a refractive beam 514b. The refractive beam 514b may hit the first features surface 502a of the first raised portion 506a and part of the refractive beam 514b may be reflected off the first features surface 502a to generate a second reflective beam 516b. The second reflective beam 516b may pass through the semiconductor 500 and the reference surface 504.

The first and second reflective beams 516a and 516b may coherently add to form a reflected beam 520. In some embodiments, the reflected beam 520 may pass through the first lens 226, the aperture 236, and the second lens 234 as illustrated and described with respect to FIG. 2A and FIG. 2B, and be provided to the digital imager 228. An image may be formed using at least the intensity of the reflected beam 520. The image may be part of a collection of images that may be used to determine the distance D1.

In some embodiments, the light source A1 may also illuminate the second raised portion 506b. In a similar manner as described with respect to the first raised portion 506a, a reflected beam may be formed and captured to form an image. The image may be part of a collection of images that may be used to determine the distance D2. Modifications, additions, or omissions may be made to the semiconductor device 500 without departing from the scope of the present disclosure.

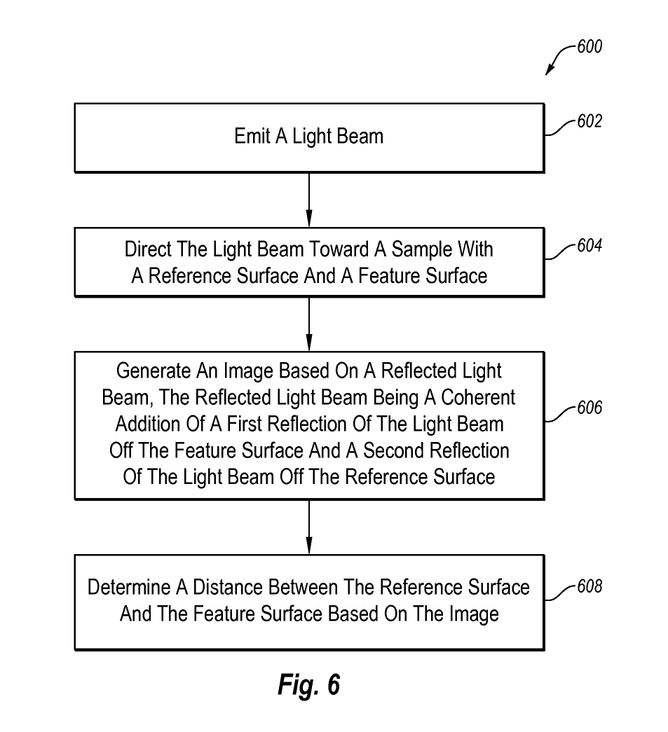

FIG. 6 is a flowchart of an example method 600 to determine a sample thickness or feature height, arranged in accordance with at least some embodiments described in this disclosure. The method 600 may be implemented, in some embodiments, by a system, such as the system 100a, 200A, or 200B of FIGS. 1, 2A, and 2B, respectively. Although illustrated as discrete blocks, various blocks may be divided into additional blocks, combined into fewer blocks, or eliminated, depending on the desired implementation.

The method 600 may begin at block 602, where a light beam may be emitted. In block 604, the light beam may be directed toward a sample with a reference surface and a feature surface.

In block 606, an image may be generated based on a reflected light beam. The reflected light beam may be a coherent addition of a first reflection of the light beam off the feature surface and a second reflection of the light beam off the reference surface.

In block 608, a distance between the reference surface and the feature surface may be determined based on the image. In some embodiments, determining the distance between the reference surface and the feature surface based on the image may include comparing an intensity of a pixel of the image to multiple pixel intensity models that correspond with different distances. Determining the distance may also include selecting one of the multiple pixel intensity models based on the intensity of the pixel. In these and other embodiments, the determined distance may be the distance corresponding to the one of the multiple pixel intensity models.

One skilled in the art will appreciate that, for this and other processes and methods disclosed in this disclosure, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, in some embodiments, the method 600 may include adjusting a size of an aperture, through which the reflected light beam passes, based on an area of a feature along the feature surface for which the distance between the reference surface and the feature surface is determined.

In some embodiments, the light beam may be a first light beam with a first wavelength that is emitted at a first time, the reflected light beam may be a reflected first beam, and the image may be a first image. In these and other embodiments, the method 600 may further include emitting a second light beam of a second wavelength at a second time different from the first time and directing the second light beam toward the sample. The method 600 may further include generating a second image based on a reflected second light beam. The reflected second light beam may be a coherent addition of a first reflection of the second light beam off the feature surface and a second reflection of the second light beam off the reference surface. The method 600 may further include determining a distance between the reference surface and the feature surface based on the first image and the second image.

In these and other embodiments, a wavelength difference between the first wavelength and the second wavelength may be selected based on the distance between the reference surface and the feature surface. In these and other embodiments, determining the distance between the reference surface and the feature surface based on the first image and the second image may include constructing a waveform or fringe pattern based on a first intensity value from the first image of and a second intensity value from the second image and performing a Fast Fourier Transform on the waveform or fringe pattern. In these and other embodiments, the distance between the reference surface and the feature surface at a first location on the sample may be determined based on a first intensity value at a first pixel location in the first image and a second intensity value at the first pixel location in the second image. In these and other embodiments, the distance may be a first distance and the method 600 may further include determining a second distance between the reference surface and the feature surface based on the first image and the second image at a second location on the sample. The second distance may be determined based on a first intensity value at a second pixel location in the first image and a second intensity value at the second pixel location in the second image.

In some embodiments, the light beam may be a first light beam, the reflected light beam may be a reflected first beam, the sample may be a first sample that is part of a semiconductor built on a wafer, and the image may be a first image. In these and other embodiments, the method 600 may further include emitting a second light beam and directing the second light beam toward a second sample of the semiconductor. The second sample of the semiconductor may be unilluminated by the first light beam and located on a different part of the semiconductor than the first sample. The method 600 may further include generating a second image based on a reflected second light beam. The reflected second light beam may be a coherent addition of a first reflection of the second light beam off the feature surface and a second reflection of the second light beam off the reference surface. The method 600 may further include determining a second distance between the reference surface and the feature surface at the second location on the semiconductor based on the second image.

Terms used in this disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description of embodiments, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in this disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

What is claimed is:

1. An interferometer system, comprising:
a tunable light source configured to emit a light beam;
a beam direction unit configured to direct the light beam toward a sample with a reference surface and a feature surface;
a digital imager configured to receive a reflected light beam and to generate a digital image based on the reflected light beam, the reflected light beam being a coherent addition of a first reflection of the light beam off the feature surface and a second reflection of the light beam off the reference surface; and
a processor system coupled to the digital imager, the processor system configured to determine a distance between the reference surface and the feature surface based on the digital image.

2. The interferometer system of claim 1, wherein the light beam is a first light beam that has a first wavelength and is emitted at a first time, the reflected light beam is a reflected first light beam, and the digital image is a first digital image, wherein:
the tunable light source is configured to emit the first light beam at a first time and is further configured to emit a second light beam of a second wavelength at a second time different from the first time;
the beam direction unit is configured to receive and direct the second light beam toward the sample;
the digital imager is configured to receive a reflected second light beam and to generate a second digital image based on the reflected second light beam, the reflected second light beam being a coherent addition of a first reflection of the second light beam off the feature surface and a second reflection of the second light beam off the reference surface; and
the processor system is configured to determine the distance between the reference surface and the feature surface based on the first digital image and the second digital image.

3. The interferometer system of claim 2, wherein the tunable light source is configured to emit a plurality of light beams, the plurality of light beams including the first light beam and the second light beam and each of the plurality of light beams having a different wavelength, a number of the plurality of light beams emitted by the tunable light source is selected based on the distance between the reference surface and the feature surface, wherein the determined distance between the reference surface and the feature surface is based on a plurality of images generated based on the plurality of light beams.

4. The interferometer system of claim 2, wherein a wavelength difference between the first wavelength and the second wavelength is selected based on the distance between the reference surface and the feature surface.

5. The interferometer system of claim 2, wherein the tunable light source includes:
a broadband light source configured to emit the first light beam at the first time and the second light beam at the second time; and
a tunable filter, the tunable filter is configured to filter the first light beam to have the first wavelength and to filter the second light beam to have the second wavelength.

6. The interferometer system of claim 2, wherein the distance between the reference surface and the feature surface at a first location on the sample is determined based on a first intensity value of a first pixel location in the first digital image and a second intensity value of the first pixel location in the second digital image.

7. The interferometer system of claim 6, wherein the distance is a first distance, wherein the processor system is configured to determine a second distance between the reference surface and the feature surface based on the first digital image and the second digital image at a second location on the sample illuminated by the first light beam and the second light beam, wherein the second distance is determined based on a first intensity value of a second pixel location in the first digital image and a second intensity value of the second pixel location in the second digital image.

8. The interferometer system of claim 1, wherein an exposure time and a gain of the digital imager is based on the distance between the reference surface and the feature surface and the reflectivity of the sample.

9. The interferometer system of claim 1, further comprising:
a first lens positioned between the sample and the digital imager;
a second lens positioned between the first lens and the digital imager; and
an adjustable system aperture positioned before the first lens or between the first lens and the second lens.

10. The interferometer system of claim 9, wherein a size of the adjustable system aperture is adjusted based on an area of a feature along the feature surface for which the distance between the reference surface and the feature surface is determined.

11. The interferometer system of claim 1, wherein the light beam is a first light beam emitted at a first time and the sample is a first sample that is part of a semiconductor built on a wafer,
wherein the tunable light source is configured to emit a second light beam at a second time different from the first time;
the beam direction unit is configured to receive and direct the second light beam toward a second sample of the semiconductor, the second sample is unilluminated by the first light beam and located on a different part of the semiconductor than the first sample;
the digital imager is configured to receive a reflected second light beam and to generate a second image based on the reflected second light beam, the reflected second light beam being a coherent addition of a first reflection of the second light beam off the feature surface and a second reflection of the second light beam off the reference surface; and
the processor system is configured to determine a second distance between the reference surface and the feature surface at the second sample on the semiconductor based on the second image.

12. A method to determine a sample thickness or feature height, the method comprising:
emitting a light beam;
directing the light beam toward a sample with a reference surface and a feature surface;
generating an image based on a reflected light beam, the reflected light beam being a coherent addition of a first reflection of the light beam off the feature surface and a second reflection of the light beam off the reference surface; and
determining a distance between the reference surface and the feature surface based on the image.

13. The method of claim 12, wherein the light beam is a first light beam with a first wavelength that is emitted at a first time, the reflected light beam is a reflected first beam, and the image is a first image, wherein the method further comprises:
emitting a second light beam of a second wavelength at a second time different from the first time;
directing the second light beam toward the sample;
generating a second image based on a reflected second light beam, the reflected second light beam being a coherent addition of a first reflection of the second light beam off the feature surface and a second reflection of the second light beam off the reference surface; and
determining a distance between the reference surface and the feature surface based on the first image and the second image.

14. The method of claim 13, wherein a wavelength difference between the first wavelength and the second wavelength is selected based on the distance between the reference surface and the feature surface and a first bandwidth of the first light beam and a second bandwidth of the second light beam is based on the distance between the reference surface and the feature surface.

15. The method of claim 13, wherein determining the distance between the reference surface and the feature surface based on the first image and the second image includes:
constructing a fringe pattern based on a first intensity value from the first image of and a second intensity value from the second image; and
performing a Fast Fourier Transform on the fringe pattern.

16. The method of claim 13, wherein the distance between the reference surface and the feature surface at a first location on the sample is determined based on a first intensity value at a first pixel location in the first image and a second intensity value at the first pixel location in the second image.

17. The method of claim 16, wherein the distance is a first distance, wherein the method further includes determining a second distance between the reference surface and the feature surface based on the first image and the second image at a second location on the sample, wherein the second distance is determined based on a first intensity value at a second pixel location in the first image and a second intensity value at the second pixel location in the second image.

18. The method of claim 12, further comprising adjusting a size of a system aperture, through which the reflected light beam passes, based on an area of a feature along the feature surface for which the distance between the reference surface and the feature surface is determined.

19. The method of claim 12, wherein determining the distance between the reference surface and the feature surface based on the image comprises:
comparing an intensity of a pixel of the image to a plurality of model based pixel intensities that correspond with different distances; and
selecting one of the plurality of model based pixel intensities based on the intensity of the pixel, wherein the determined distance is the distance corresponding to the one of the plurality of model based pixel intensities.

20. The method of claim 12, wherein the light beam is a first light beam, the reflected light beam is a reflected first beam, the sample is a first sample that is part of a semiconductor built on a wafer, and the image is a first image, wherein the method further comprises:
emitting a second light beam;
directing the second light beam toward a second sample of the semiconductor, the second sample is unilluminated by the first light beam and located on a different part of the semiconductor than the first sample;
generating a second image based on a reflected second light beam, the reflected second light beam being a coherent addition of a first reflection of the second light beam off the feature surface and a second reflection of the second light beam off the reference surface; and
determining a second distance between the reference surface and the feature surface at the second sample on the semiconductor based on the second image.
